(19) United States
(12) Patent Application Publication
(10) Pub. No.: US 2025/0336990 A1
(43) Pub. Date: Oct. 30, 2025

(54) DENDRITE-FREE ZINC-BASED FLOW BATTERY WITH HIGH AREAL CAPACITY

(71) Applicant: City University of Hong Kong, Hong Kong (HK)

(72) Inventors: Chunyi ZHI, Hong Kong (HK); Shengnan WANG, Hong Kong (HK)

(21) Appl. No.: 18/648,538

(22) Filed: Apr. 29, 2024

(51) Int. Cl. H01M 8/04082; H01M 4/86; H01M 8/04186; H01M 8/18

(52) U.S. Cl. CPC H01M 8/04201; H01M 4/8657; H01M 8/04186; H01M 8/188

(57) ABSTRACT

The present invention provides a dendrite-free zinc-based flow battery. The flow battery includes an anode integrated with a first collector, a cathode integrated with a second collector, a first storage tank comprising catholyte, a first pump connects the cathode and the first storage tank, a second storage tank comprising anolyte and liquid eutectic alloys, a second pump connects the anode and the second storage tank, and a separator to prevent direct contact between the anolyte and the catholyte. The room-temperature gallium-based liquid metals (Ga-LM) alloys enable zinc-based flow batteries (Zn-FBs) to achieve unparalleled areal capacity and exceptionally long cycle life.

### TECHNICAL FIELD

The present invention generally relates to the fields of battery technology. More specifically, the present invention relates to a liquid-zinc anode operational at room temperature, which enables ultra-high areal capacity in the flow batteries while preventing the formation of dendrites.

### BACKGROUND OF THE INVENTION

Intrinsically safe and cost-effective energy storage (ES) technologies are critical enablers for effective utilization of intermittent renewable energy resources such as solar and wind power. Aqueous redox flow batteries (ARFBs) represent a significant technology within the realm of energy storage, particularly for large-scale applications, due to their outstanding safety features, scalability, and distinctive capability of decoupling energy and power.

Zinc-based flow batteries (Zn-FBs) have attracted remarkable attention for stationary energy storage due to their intrinsic high energy density, abundant reserves and environmental friendliness. In contrast to conventional all-liquid RFBs, where active materials dissolve in electrolytes, the anode of Zn-FBs is based on zinc deposition/dissolution reactions. Consequently, the capacity of Zn-FBs is constrained by the solid electrode's capacity.

The cycling stability of Zn-FBs is strongly influenced by the areal capacity of deposited zinc, which directly affects dendrite formation. Significant endeavors have been directed towards enhancing the negative electrodes for zinc-based batteries, aiming for both high areal capacity and high current density while preventing dendrite formation. These efforts involve designing host structures, surface modification of electrodes, and optimizing electrolyte formulations. However, the formation of zinc dendrites still critically limits the energy density (areal capacity normally less than 40 mAh cm⁻²) and lifespan of all classes of zinc-based batteries, which is insufficient to meet the practical application requirements of high-energy and long-lasting Zn-FBs.

Consequently, there is a demand for the development of zinc-based flow batteries characterized by low areal capacity and devoid of dendrite formation. The present invention addresses this need.

### SUMMARY OF THE INVENTION

The present invention provides a fresh approach to tackle the persistent challenges of zinc dendrite formation and low areal capacity in zinc-based flow batteries (Zn-FBs), particularly for long-duration energy storage applications.

In a first aspect, the present invention provides a dendrite-free zinc-based flow battery with high areal capacity. The zinc-based flow battery includes an anode integrated with a first collector, a cathode integrated with a second collector, a first storage tank comprising catholyte, a first pump connects the cathode and the first storage tank, a second storage tank comprising anolyte and liquid eutectic alloys, a second pump connects the anode and the second storage tank, and a separator to prevent direct contact between the anolyte and the catholyte. The catholyte flows through the battery driven by the first pump, and the anolyte and the liquid eutectic alloys flows through the battery driven by the second pump.

In one embodiment, the anode includes carbon felt, or carbon felt with zinc plate or zinc foil added.

In one embodiment, the anolyte includes zinc salts and supporting electrolytes salts with a concentration of 0.5 to 3 mol L⁻¹. The zinc salts comprise ZnBr₂, ZnCl₂, and ZnI₂, or a combination thereof.

In one embodiment, the cathode comprises carbon felt, or a carbon felt absorbed with catholyte.

In one embodiment, the catholyte includes one or more Cl⁰/Cl⁻, Br₂/Br⁻, I⁰/I⁻, Fe³⁺/Fe²⁺ salts and supporting electrolytes salts with a concentration of 0.5 to 3 mol L⁻¹. The supporting electrolytes salts include NaCl, KCl and NH₄Cl, or a combination thereof.

In one embodiment, the liquid eutectic alloys comprise room-temperature liquid metals based on gallium or mercury. The gallium-based room-temperature liquid metals include EGaInSnZn alloys, and the EGaInSnZn alloys are capable of returning to EGaInSn alloys after discharge.

In another embodiment, the EGaInSnZn alloys exhibit the characteristic broad peak at around 35°.

In yet another embodiment, the EGaInSnZn alloys comprises 50-80 wt % gallium, 10-30 wt % indium, 5-20 wt % tin and 1-10 wt % zinc.

In one embodiment, the separator includes porous membrane or an ion exchange membrane with a thickness of 10 to 200 μm.

In one embodiment, the first collector or the second collector can be graphite plate, carbon plastic composite plate or titanium plate.

In one embodiment, the volume ratio between anolyte:LM is in a range of 5-20.

In one embodiment, the dendrite-free zinc-based flow battery demonstrates an areal capacity of at least 600 mAh cm⁻² at a current density of at least 40 mA cm⁻².

In one embodiment, the dendrite-free zinc-based flow battery exhibits at least 95% of coulombic efficiency, at least 84% of energy efficiency even if the areal capacity is increased up to 640 mAh cm⁻².

In one embodiment, the dendrite-free zinc-based flow battery maintains a cycle life of at least 110 days even at an areal capacity of 120 mAh cm⁻².

In another embodiment, the dendrite-free zinc-based flow battery maintains a cycle life of at least 170 days even at an areal capacity of 120 mAh cm⁻².

In one embodiment, the dendrite-free zinc-based flow battery displays a stable charging/discharging performance for over 4000 hours.

The following are the novel features of the invention that are not present in current technology: the unique liquid-liquid electrode-electrolyte interface and intrinsic self-healing properties of zinc-deposited LM alloy enable Zn-FBs to operate at high current densities without solid dendrite growth; the eutectic alloy zinc wrapped in LM reduces contact with the electrolyte, mitigate the in-situ electrochemical corrosion and obtains high round-trip efficiencies; the operating method is very simple and easy to execute without any difficulty.

### BRIEF DESCRIPTION OF THE DRAWINGS

Embodiments of the invention are described in more details hereinafter with reference to the drawings, in which:

FIG. 1A shows digital photographs of zinc-deposited LM alloy in various states. FIG. 1B shows a schematic illustration of zinc dissolving in gallium-based LM (Ga-LM) alloys to form a eutectic alloy at room-temperature;

FIG. 2 shows a phase diagram of Zn-LM system along with experimental determination (star position);

FIG. 3 depicts differential scanning calorimetry (DSC) curves for zinc-deposited LM alloys with different contents of electrodeposited zinc during cooling;

FIG. 4 depicts XPS full spectra of pristine and charged zinc-deposited LM alloys;

FIG. 5A depicts high-resolution XPS Zn 2p spectra of zinc-deposited LM and pristine zinc foil. FIG. 5B depicts TOF-SIMS spectrum of zinc-deposited LM;

FIG. 6 shows a schematic representation of a zinc-based flow battery assembled with zinc-deposited LM alloys;

FIG. 7A depicts the performance of a zinc-iodine flow battery (ZIFB) with zinc-deposited LM alloys at areal capacities ranging from 40 to 640 mAh cm⁻². FIG. 7B depicts galvanostatic charging-discharging profiles of ZIFB without zinc-deposited LM alloys at areal capacities ranging from 40 to 200 mAh cm⁻². FIG. 7C depicts charge-discharge curves of ZIFB with zinc-deposited LM alloys in long-duration energy storage experiment;

FIG. 8 depicts a comparison of the areal capacity and cycle time achieved in ZIFBs reported in the present invention, compared to the respective state-of-the-art performance reported in contemporary literature studies;

FIG. 9 shows digital photographs of zinc-deposited LM alloys before and after charge/discharge cycles;

FIG. 10 depicts XRD patterns of LMs before and after multiple charges;

FIG. 11A depicts the reduction and diffusion energy barriers of zinc atoms on the LM and metallic zinc surfaces. FIG. 11B shows the corresponding initial state (IS), transition state (TS), and final state (FS) structures of zinc atom migrating on LM surface. FIG. 11C shows the corresponding IS, TS, and FS structures of zinc atom migrating on Zn (101) interface;

FIG. 12 shows SEM images of zinc-deposited LM alloys before and after charge/discharge;

FIGS. 13A-13C show elemental maps of LM before and after charge/discharge;

FIG. 14 depicts the atomic ratio of elements in LM after 20th charge and discharge;

FIG. 15A shows SEM and SDM images of electrodes from the batteries with or without LM alloys. FIG. 15B shows a digital photograph of CF and membrane from ZIFB without LM alloys after 20 times of charging at 120 mAh cm⁻². FIG. 15C shows optical micrographs of CF and membrane from ZIFB without LM alloys after 20 times of charging at 120 mAh cm⁻². FIG. 15D depicts XRD pattern of CF from ZIFB without LM alloys after 20 times of charging at 120 mAh cm⁻²;

FIG. 16A shows SEM and SDM images of membranes from the batteries with or without LM alloys. FIG. 16B shows cross-sectional morphologies of membrane from ZIFB with or without LM alloys after 20 times of charging at 120 mAh cm⁻². FIG. 16C depicts galvanostatic charging-discharging profiles of ZIFB without LM at 120 mAh cm⁻²;

FIG. 17A shows a digital photograph of GP and membrane from ZIFB with LM alloys after 20 times of charging at 120 mAh cm⁻². FIG. 17B shows optical micrographs of GP and membrane from ZIFB with LM alloys after 20 times of charging at 120 mAh cm⁻². FIG. 17C depicts XRD pattern of GP from ZIFB with LM after 20 times of charging at 120 mAh cm⁻²;

FIG. 18A shows a digital photograph of GP and membrane before charge. FIG. 18B shows a SEM image of GP before charge. FIG. 18C shows an optical micrograph of GP before charge. FIG. 18D shows a SDM image of GP before charge;

FIG. 19 shows SEM and SDM images of membrane before charge;

FIG. 20 shows a schematic illustration of zinc deposition process without and with LM alloys;

FIG. 21A depicts cycling performance of ZIFBs with and without LM at 120 mAh cm⁻².

FIG. 21B depicts voltage profiles of ZIFBs with and without LM in FIG. 21A. The insets show the representative voltage profiles over cycling. FIG. 21C depicts cumulative areal discharge capacity of ZIFB with LM after undergoing 600 cycles of continuous tests for 5 months;

FIG. 22A depicts performance of ZIFB without CF at areal capacities ranging from 40 to 240 mAh cm⁻². FIG. 22B depicts voltage profiles of ZIFB without CF at areal capacities ranging from 40 to 240 mAh cm⁻²;

FIG. 23A depicts charging-discharging curves of ZIFBs with and without LM alloys after 6 h rest at the charge state. FIG. 23B depicts the efficiencies of ZIFBs with and without LM alloys at current densities ranging from 20 to 60 mA cm⁻². FIG. 23C depicts extended cycling of ZIFB with LM alloys in long-duration energy storage experiment with an areal capacity of 480 mAh cm⁻². FIG. 23D depicts voltage profiles of ZIFB with LM at 480 mAh cm⁻². The insets show the representative voltage profiles over cycling;

FIG. 24A depicts performance of ZBFB with LM alloys at areal capacities ranging from 40 to 640 mAh cm⁻². FIG. 24B depicts cycling performance of ZBFB at 120 mAh cm⁻² with and without LM alloys. FIG. 24C depicts cycling performance of ZBFB with LM alloys in long-duration energy storage experiment with an areal capacity of 240 mAh cm⁻²;

FIG. 25 depicts voltage profiles of ZBFBs with and without LM at 120 mAh cm⁻². The insets show the representative voltage profiles over cycling; and

FIG. 26 depicts cycling performance of ZIFB with LM (gallium 66 wt %, indium 20.5 wt % and tin 13.5 wt %) at 120 mAh cm⁻².

### DETAILED DESCRIPTION

Zn-based flow batteries (Zn-FBs) are highly suitable for stationary energy storage, benefiting from their abundant reserves, natural safety, high capacity, and high cell voltage (low electrochemical potential of the Zn redox couple, −0.763 V vs. SHE in neutral media, −1.245 V vs. SHE in alkaline media). Nonetheless, the anode operation involves a zinc deposition/dissolution mechanism, plagued by significant dendrite formation and limited reversibility, particularly under high areal capacities.

Accordingly, the present invention provides a dendrite-free zinc-based flow battery with high areal capacity. The zinc-based flow battery includes an anode integrated with a first collector, a cathode integrated with a second collector, a first storage tank comprising catholyte, a first pump connects the cathode and the first storage tank, a second storage tank comprising anolyte and liquid eutectic alloys, a second pump connects the anode and the second storage tank, and a separator to prevent direct contact between the anolyte and the catholyte. The catholyte flows through the battery driven by the first pump, and the anolyte and the liquid eutectic alloys flows through the battery driven by the second pump. The original liquid-solid electrochemical reaction of zinc deposition/dissolution is transformed into a liquid-liquid process, and thus providing an opportunity to achieve high areal capacity zinc anode without dendrite formation.

In particular, the present invention provides a novel liquid-zinc electrode employing a gallium-based liquid metal (Ga-LM) alloy as a replacement for conventional liquid-solid conversion zinc electrodes.

Liquid metals have both metallic and fluidic properties. Their intrinsic properties include deformability, high electrical conductivity, and superior electrochemical performance. In addition, the unique liquid-liquid electrode-electrolyte interface and intrinsic self-healing properties of LM alloy enable Zn-FBs to operate at high current densities without solid dendrite growth. Room-temperature LM alloys, particularly Ga-LM alloys, show great promise as electrode materials for zinc-based flow batteries due to their safety, lack of toxicity, self-healing properties, and established solubility with other metals.

The dendrite-free zinc-based flow battery demonstrates an areal capacity of at least 600 mAh cm⁻² at a current density of at least 40 mA cm⁻². Preferably, the dendrite-free zinc-based flow battery demonstrates an areal capacity of up to 640 mAh cm⁻² at a current density of at least 40 mA cm⁻².

In one embodiment, the LM alloys have a relatedly low melting point (MP), exhibiting the liquid state at or near room-temperature. The melting point of the LM alloys is in a range of _8_-_20_° C.

The liquid eutectic alloys may include room-temperature liquid metals based on gallium or mercury. Preferably, the liquid eutectic alloys are gallium-based liquid metal alloys.

As a representative of Ga-LM alloys with low melt point, the safe eutectic gallium-indium-tin (EGaInSn) is studied as a widely applicable reference in the present invention.

LM accepted zinc ions during the charge process to form the liquid EGaInSnZn alloy, and the EGaInSnZn alloys are capable of returning to EGaInSn alloys after discharge.

Zn in the catholyte undergoes an oxidation reaction to generate Zn²⁺, while the active material Zn²⁺ in the anolyte undergoes a reduction reaction to generate Zn. The positive electrode pair requires a higher electrode potential than the Zn²⁺/Zn.

In one embodiment, the anode may include carbon felt, or carbon felt with zinc plate or zinc foil added.

In one embodiment, the anolyte may include zinc salts and supporting electrolytes salts with a concentration of 0.5 to 3 mol L⁻¹. The zinc salts may include ZnBr₂, ZnCl₂, and ZnI₂, or a combination thereof.

Preferably, the concentration of anolyte is in a range of 1 to 2 mol L⁻¹.

In one embodiment, the cathode may include carbon felt, or a carbon felt absorbed with catholyte.

In one embodiment, the catholyte may include one or more Cl⁰/Cl, Br₂/Br⁻, I⁰/I⁻, Fe³⁺/Fe²⁺ salts and supporting electrolytes salts with a concentration of 0.5 to 3 mol L⁻¹. The supporting electrolytes salts may include NaCl, KCl and NH₄Cl, or a combination thereof.

Preferably, the concentration of catholyte is in a range of 1 to 2 mol L⁻¹.

In the present invention, the EGaInSnZn alloys include 50-80 wt % gallium, 10-30 wt % indium, 5-20 wt % tin and 1-10 wt % zinc.

In one embodiment, the composition of EGaInSn is 68.5% Ga, 21.5% In, and 10.0% Sn by weight.

In one embodiment, the flow battery may include a single cell or a stack composed of two or more single-cell circuits connected in series.

In one embodiment, the separator may include porous membrane or an ion exchange membrane with a thickness of 10 to 200 μm.

Preferably, the separator is polyolefin porous membrane.

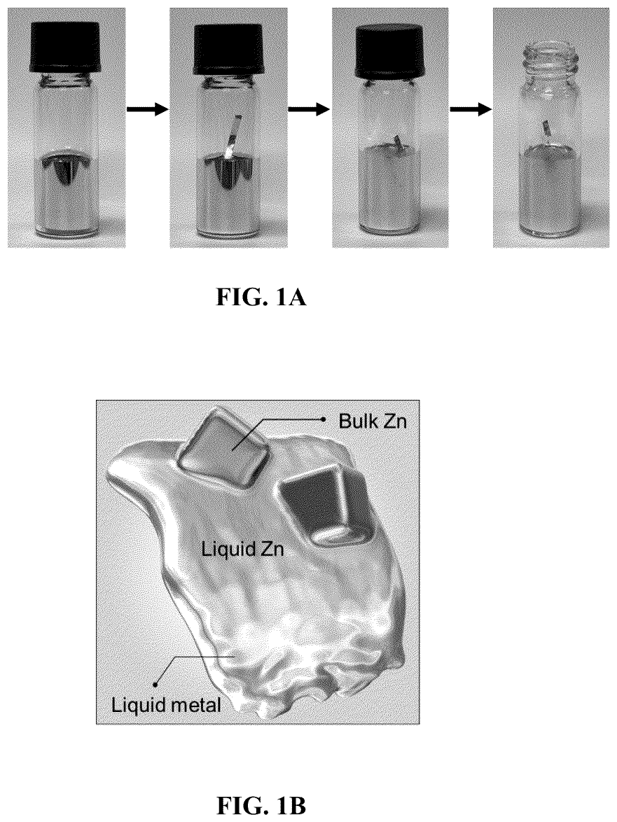

FIG. 1A shows digital photographs of LM alloys in various states: (a) pristine; (b) immediately after the addition of the zinc foil strip; (c) after standing; and (d) after removal of the zinc foil strip. In step (b), the end of the zinc foil strip is immersed in LM. The zinc foil strip becomes shorter after contacting with LM, and the shortened part is dissolved in LM. Upon dissolving metallic zinc in the common eutectic gallium-indium-tin (EGaInSn) liquid metal, solid zinc undergoes conversion into stretchable liquid zinc, as illustrated in FIG. 1B. Subsequently, it transforms into eutectic gallium-indium-tin-zinc (EGaInSnZn) liquid metal.

The present invention provides ultra-high areal capacity and dendrite-free zinc-based flow batteries (Zn-FBs) while ensuring excellent cycling stability. The charge/discharge of the anode corresponds to alloying/dealloying reactions of zinc in LM, which effectively removes space constraints on zinc deposition within the battery. The deposition/dissolution of Zn²⁺/Zn pair also corresponds to alloying/dealloying reaction of zinc in LM. The liquid-zinc electrode can flow freely past the Zn-FBs, getting rid of the spatial restrictions on zinc capacity of the battery device during solid-phase deposition, so that the capacity can be quickly enlarged and flexibly designed.

The capacity of Zn-FBs with LM depends on the amount of LM in the electrolyte. Therefore, by adjusting the addition amount of LM alloys, batteries with required discharge time can be flexibly designed to adapt to different energy storage scenarios.

In one embodiment, the volume ratio between anolyte:LM is in a range of 5-20.

The liquid Zn-LM alloy could be continually removed from the reactor, preventing the self-corrosion of zinc caused by direct contact with the anolyte and reducing the self-discharge of the electrolyte interpenetration. This enabled the battery to maintain high Coulombic Efficiency (CE) for long-term operation at low current density.

In one embodiment, both zinc-iodine flow batteries (ZIFBs) and zinc-bromine flow batteries (ZBFBs) with Ga-LM alloys achieve an unprecedentedly areal capacity of 640 mAh cm⁻² at a high current density of 40 mA cm⁻² and a long cycle life over 170 and 110 days at high areal capacity of 120 mAh cm⁻², respectively.

In one embodiment, the dendrite-free zinc-based flow battery displays a stable charging/discharging performance for over 4000 hours.

### EXAMPLES

The examples and embodiments described herein are for illustrative purposes only and various modifications or changes in light thereof will be suggested to persons skilled in the art and are included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### Example 1

### Material and Methods

Potassium iodide (KI), zinc bromide (ZnBr₂), potassium chloride (KCl) and 1-ethyl-1-methylpyrrolidinium bromide (MEP) were purchased from Aladdin (China). All electrolytes were prepared with deionized water. Carbon felt (CF) was purchased from Liaoyang J-Carbon Materials Co., Ltd. (China) and used as received. Liquid metal alloy was synthesized via a facile melting method by heating the mixture of metallic gallium (Ga), indium (In) and tin (Sn) with a mass ratio of 68.5:21.5:10 at a temperature of 100° C. in an Ar atmosphere.

### Flow Battery Performance

The zinc-based flow battery was assembled by sandwiching a porous polyolefin membrane (Daramic) between two CF electrodes clamped by two graphite plates (GP). For zinc-iodine flow batteries (ZIFBs), the anolyte and catholyte were the same, containing 2 mol L⁻¹ KI, 1 mol L⁻¹ ZnBr₂, and 2 mol L⁻¹ KCl. For zinc-bromine flow batteries (ZBFBs), the anolyte contained 2 mol L⁻¹ ZnBr₂ and 3 mol L⁻¹ KCl. The catholyte required a bromine complexing agent to slow down the diffusion of corrosive bromine, and 0.4 mol L⁻¹ 1-ethyl-1-methylpyrrolidinium bromide (MEP) was added. The different concentration electrolytes were used to flow pass the batteries. For batteries with LM, no carbon felt was used on the negative side, and the LM added to the anolyte tank flowed through the reactor together with the anolyte.

In the test experiment with increasing zinc areal capacity, the added amount of LM was 15 ml. For ZIFBs without carbon felt (CF) and LM at the negative electrode, the cavity was empty and only anolyte flowed through it. The geometric area of the electrode was 2×2 cm², and the effective reaction area was 3.75 cm². The batteries were operated at a constant current density and the charge process was controlled by the capacity of anolyte. The discharge process was ended with a cut-off voltage of 0.1 V. All the battery performance tests were conducted by CT3001A, LAND Battery Testing System.

### Computational Method

The absorption energy the liquid metal system (EGaInSn, gallium 68.5 wt %, indium 21.5 wt % and tin 10.0 wt %) was calculated in a 13.7×13.7×13.7 Å box. The close-packed Zn (101) and (002) surface with a p(4×4) supercell was constructed based on the optimized bulk structure. And an approximately 12 Å vacuum was used for liquid metal and bulk Zn surface slabs, respectively, to prevent any undesired interactions. Density functional theory (DFT) and Ab initio molecular dynamics (AIMD) simulations were conducted utilizing the Vienna Ab initio Simulation Package (VASP) with the projector-augmented wave (PAW) pseudopotentials. The exchange-correlation interactions between the valence electrons were taken into account using the Perdew-Burke-Ernzerhof (PBE) functional within the generalized gradient approximation (GGA). The plane-wave energy was set to 400 eV for both liquid metal and bulk Zn systems. Additionally, Grimme's empirical method (DFT-D3) was employed to simulate the vander Waals (vdW) correction in the total energy and force of atoms.

The classical models of liquid metal may not guarantee a stable configuration at the DFT level. Hence, AIMD simulations for liquid metal in the canonical ensemble (NVT) were conducted at different temperatures (298.15 and 1000K) to assess structural stability. The timestep for both simulations was set to 1 fs for a duration of 3 ns at varying temperatures. A Nosé-Hoover thermostat was implemented for all NVT simulations. The lattice parameters were constrained, while all atoms were allowed to move. Geometries were optimized using the AIMD-relaxed geometry for high-level DFT calculation until the energy and force were converged to 10⁻⁵ eV/atom and 0.03 eV/Å, respectively. Spin-polarized effects were also considered. The Brillouin zones for liquid metal and bulk Zn models were sampled with 2×2×1 and 3×3×1 k-point meshes grid, respectively, according to the Monkhorst Pack method. The climbing-image nudge elastic band (CI-NEB) method was used to identify the transition states and reaction pathways. The vibrational frequency calculations for all stationary points were conducted to characterize the optimized structures.

### Example 2—Compatibility of the LM with Metallic Zinc

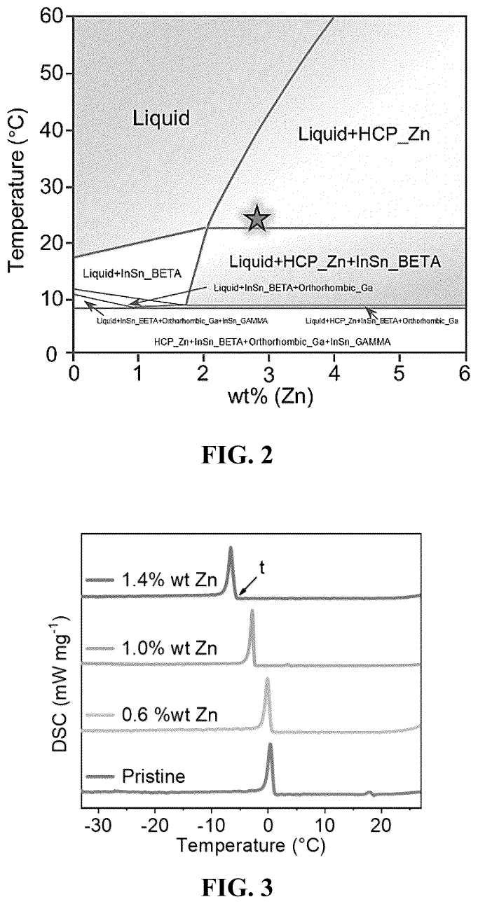

In this example, a thermodynamic assessment on the Zn-LM system was performed. The fixed weight ratio of LM alloy is 68.5% Ga, 21.5% In, and 10.0% Sn. Referring to FIG. 2, the LM system has a melting point well below room-temperature and a high theoretical capacity for zinc.

As a refinement of the calculation results, zinc foil was immersed in LM alloy at room temperature for an extended period to ascertain the solubility of zinc. It was discovered that zinc demonstrated high solubility in LM alloy, with up to 2.9 wt % of zinc capable of being added to form a eutectic alloy of EGaInSnZn. The LM containing abundant storage sites accepted zinc ions during the charging process. Upon discharge, it reverted back to the eutectic EGaInSn, facilitating reversible liquid-liquid phase transitions within the liquid-zinc alloy anode during both charging and discharging cycles.

A differential scanning calorimeter (DSC, Netzsch DSC 200 F3) was used to measure the freezing temperature points of LM alloys with different zinc content at a cooling rate of 1° C. min 1 over the temperature range of −30 to 30° C. Referring to FIG. 3, increasing the content of electrodeposited zinc (0.6 wt % to 1.4 wt %) in the LM offered a decreased liquid-to-solid phase transition temperature (t). All t below 1.09° C. indicated that the liquid-zinc anode had a wide operating temperature range. These properties suggested the potential of LMs in the development of room-temperature zinc-ion-driven LM batteries featuring innovative liquid-liquid electrochemical interfaces.

### Example 3—Surface Chemical Elemental Composition and Chemical States of the Charged LM

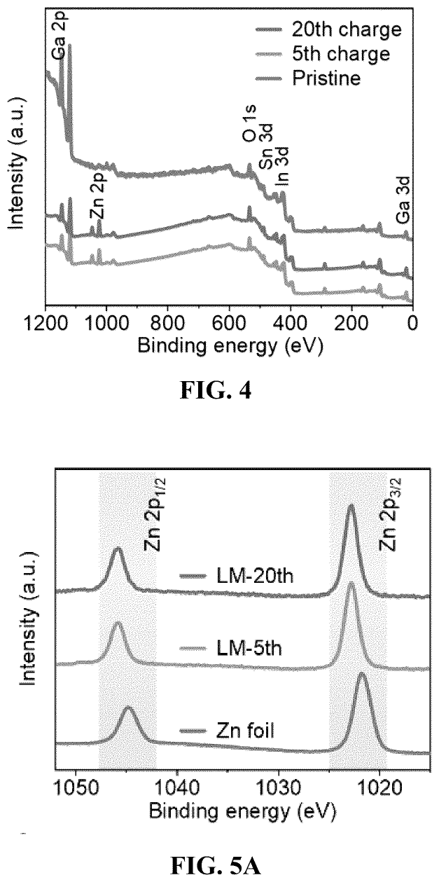

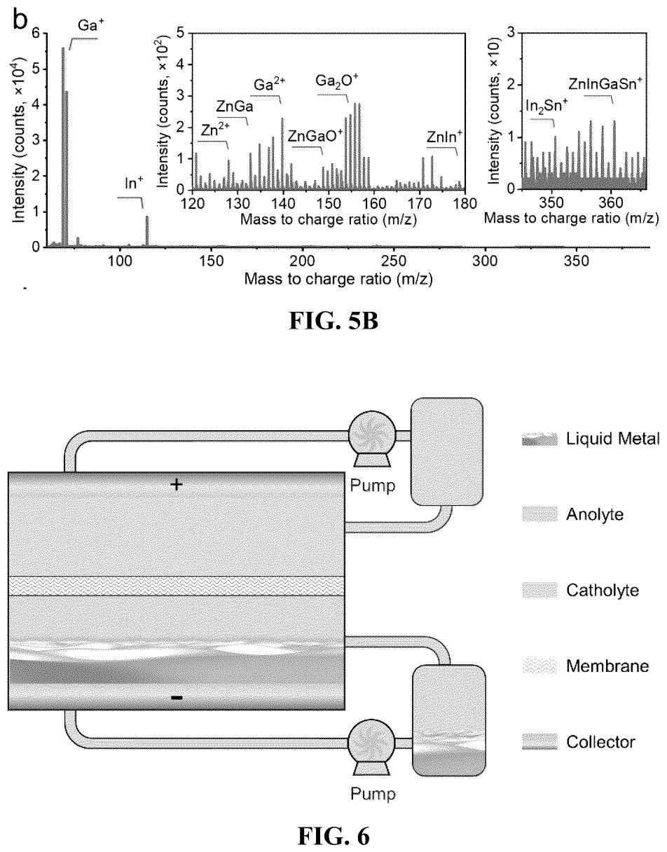

To gain further insight into the zinc deposition process in LM, X-ray photoelectron spectra (XPS) analyses were conducted. X-ray photoelectron spectroscopy (XPS) was collected on the Thermo Scientific K-Alpha equipment. FIG. 4 showed the XPS full spectra of pristine and charged zinc-deposited LM alloys. The results revealed the existence of Ga, In, Sn, and Zn elements. FIG. 5A showed the Zn 2p spectrum of the charged LM and bare zinc, and the peaks at about 1045.8 eV (1044.8 eV) and 1022.8 eV (1021.8 eV) belong to Zn 2p_{1/2} and Zn 2p_{3/2}, respectively. Compared with pure zinc foil, the Zn 2p_{1/2} and Zn 2p_{3/2} peaks position of charged zinc-deposited LM alloys were shifted to a higher binding energy, indicating the formation of EGaInSnZn alloy, and these results were further supported by time-of-flight secondary-ion mass spectrometry (TOF-SIMS). TOF-SIMS was conducted by the PHI NanoTOFIII instrument. The contents of Ga, In, Sn and Zn elements in LM were analysed by inductively coupled plasma mass spectrometry (Agilent 720ES). The signals of ZnGaO⁺, ZnGa⁺, ZnIn⁺ and ZnInGaSn⁺ were directly observed in FIG. 5B, indicating that zinc deposited in LM would exist in the form of an alloy with EGaInSn. These signals provided information about the chemical interactions and compound formations between zinc and other elements such as gallium, indium, and tin.

Compared with solid-phase deposited zinc, alloy-phase zinc wrapped by LM alloys reduced contact with the electrolyte and mitigates the electrochemical corrosion of zinc.¹⁵

### Example 4—Preparation of Zinc-Iodine Flow Battery with LM Alloys

FIG. 6 showed a schematic illustration of Zn-FBs with LM alloys, in which electrolytes and LM alloys were circulated from at least one external electrolyte tank through the cell stack via different pumps. The LM alloys played dual roles of electrode and current collector.

In an example, a zinc-iodine flow battery (ZIFB) was prepared as follow: A ZIFB was constructed by sandwiching a porous polyolefin membrane (Daramic) between two carbon felt electrodes, clamped by two graphite plates. The same anolyte and catholyte were used, containing 2 mol L⁻¹ KI, 1 mol L⁻¹ ZnBr₂, and 2 mol L⁻¹ KCl.

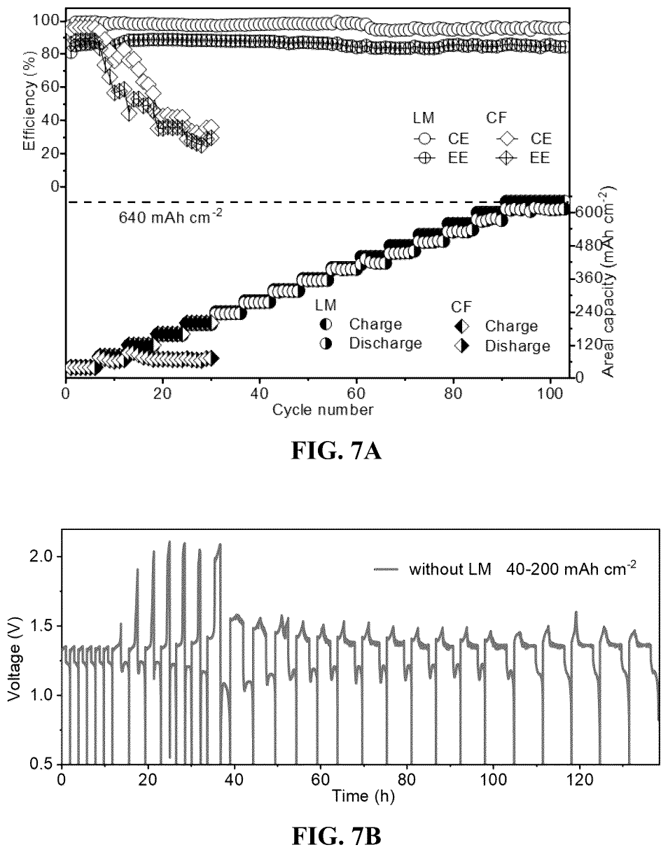

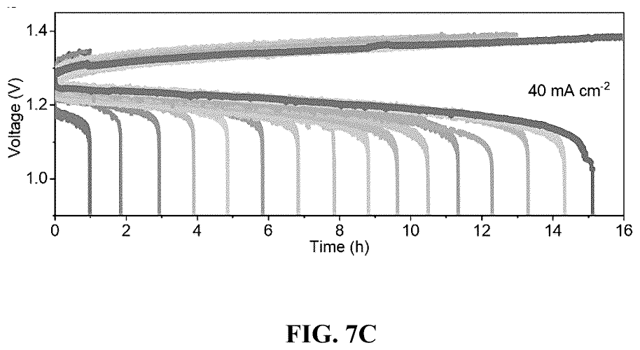

FIG. 7A showed a direct comparison of the areal capacity, Coulombic efficiencies (CEs) and energy efficiencies (EEs) of ZIFBs with and without LM alloys operated with various areal capacities from 40 to 640 mAh cm⁻² at a fixed current density of 40 mA cm⁻². When the areal capacity increased to 80 mAh cm⁻², the CEs and EEs of the ZIFB without LM began to fluctuate. Although higher areal capacities could be obtained with increasing cycles, the ZIFB without LM suffered a serious capacity decay and voltage fluctuation (FIG. 7B), which was indicative of zinc dendrite formation. These results indicated that the zinc deposition areal capacity of pristine ZIFB was typically less than 80 mAh/cm². In contrast, ZIFB with LM alloys could maintain high CE of 95.7% and high EE of 85.1% even if the areal capacity was increased up to 640 mAh cm⁻² (currently the highest value for zinc-based batteries). In addition, ZIFB with LM alloys demonstrated highly stable charge-discharge curves with long discharge/charge durations, which further showed great potential for long-duration energy storage (FIG. 7C).

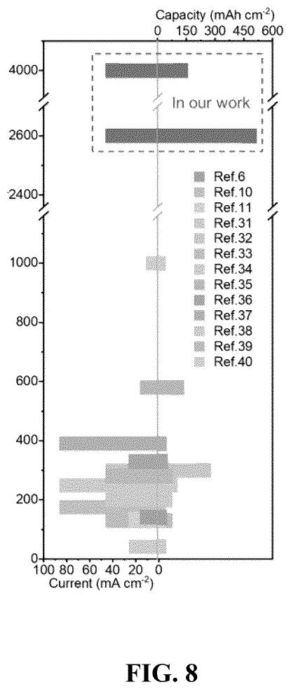

Turning to FIG. 8, by comparing the pivotal performance parameters in the aspect of areal capacity, current density and cycle life, the ZIFB of the present invention achieved the highest areal capacity as well as a superb cycling stability at current densities above 40 mA cm⁻², and demonstrated the unique advantage and practicability of using liquid-liquid phase conversion type liquid-zinc anode Zn-FB system.¹⁻¹³

### Example 5—Zinc Plating and Stripping Behaviours in LM

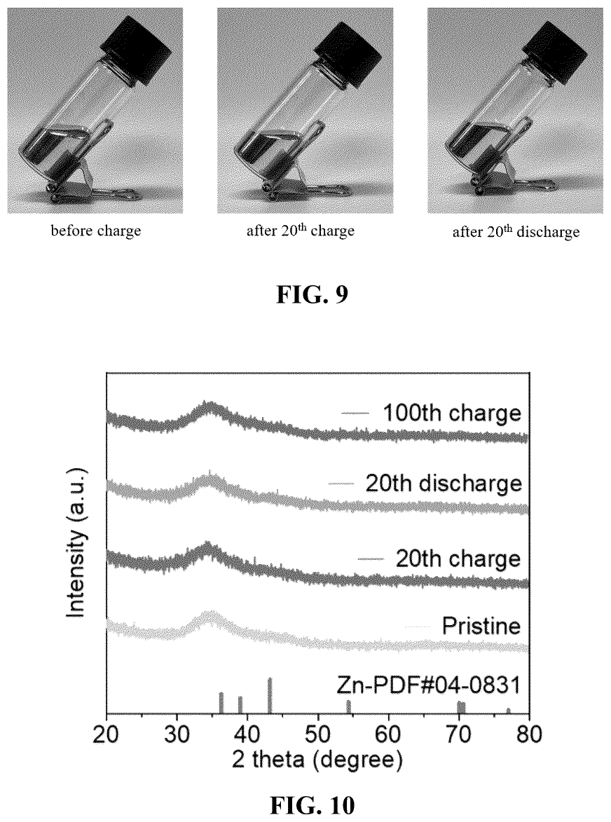

The ultra-high zinc deposition areal capacity and excellent cycling performance of Zn-FBs is mainly attributed to the fluidity and self-healing behaviours of the liquid. 14 As shown in FIG. 9, the LM alloys experienced multiple cycles of zinc deposition/dissolution were still liquid, intuitively confirming its stability as an electrode material.

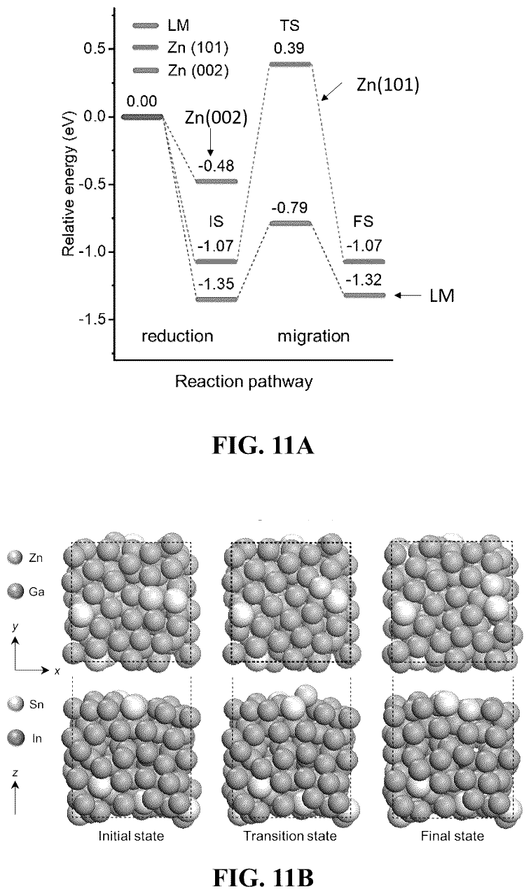

The X-ray diffraction (XRD) patterns of LM alloys were obtained by using an X-ray diffractometer (Rigaku SmartLab 9 kW). XRD was used to investigate the structure of LM alloys before and after multiple charges. Referring to FIG. 10, the XRD spectrum of the zinc-deposited LM exhibited the characteristic broad peak at around 35° due to the liquid alloy phase, indicating the co-existence of the EGaInSn liquid alloy and Zn.

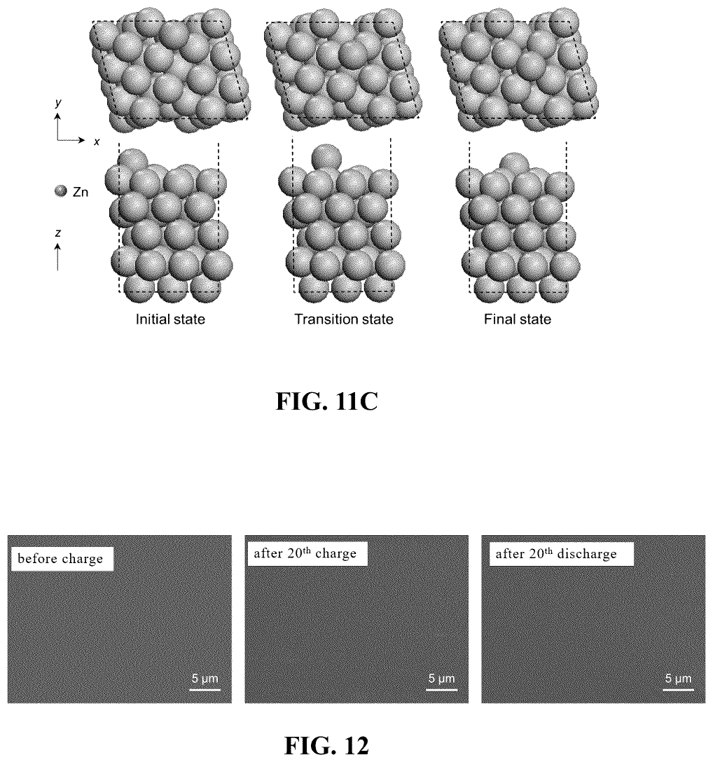

The nucleation process of zinc deposition comprised two steps: the reduction and migration of zinc atoms at the interface. To further gain an insight into the zinc plating process at the atomic level, density functional theory (DFT) and Ab initio molecular dynamics (AIMD) simulations were carried out to investigate the adsorption and migration energies of zinc atoms on different surfaces. Referring to FIG. 11A, the calculated adsorption energy (Eₙ) values of zinc atoms on Zn (002) and Zn (101) substrates were −0.48 and −1.07 eV, respectively, which were substantially higher than those of LM alloy (−1.35 eV), indicating that due to the liquid-liquid interface, the LM exhibited a strong affinity for zinc and was more prone to nucleation.

Moreover, the energy barriers for a zinc atom migration across the LM and Zn (101) interfaces were calculated, as depicted in FIGS. 11B-11C. The results indicated that when the zinc atom migrated between two adjacent hole sites on the Zn (101) facets, the diffusion energy barrier was about 1.46 eV. However, the diffusion energies of zinc atom on LM alloys were reduced to about 0.56 eV, which are much lower than that of zinc metal substrate.

In addition, the physical flow of zinc-deposited LM alloys in Zn-FBs also accelerated the migration and alloying process of zinc atoms in the LM alloys. The lower diffusion barrier facilitated the diffusion mobility of surface adatoms, typically resulting in enhanced zinc redox kinetics and uniform, dendrite-free zinc deposition.

### Example 6—Morphology and Microstructure Changes of Zinc-Deposited LM Alloys Before and After Charge/Discharge

The microstructure and elemental distribution of electrode, membrane and LM were characterized by field emission scanning electron microscope (SEM, JEOL-7001F) equipped with an energy-dispersive X-ray spectroscopy (EDS).

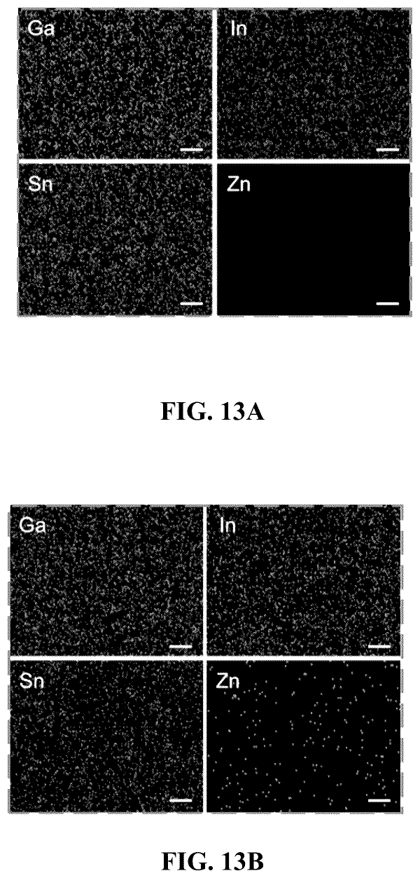

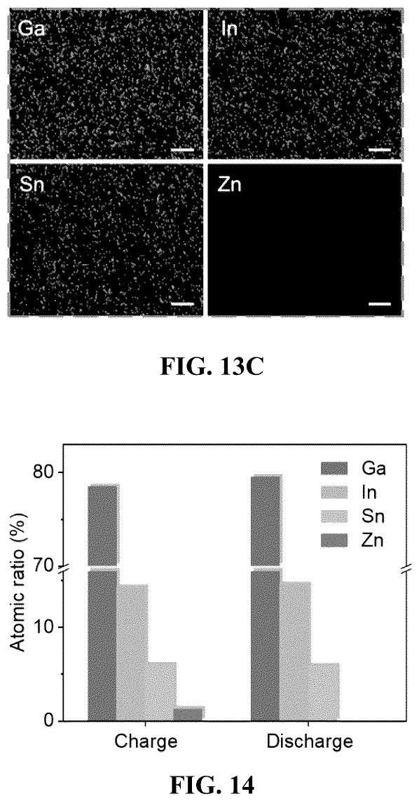

As presented in FIG. 12, the morphology of the LMs showed no obvious changes. Additionally, EDS images of LM in different states displayed a uniform elemental distribution of Ga, In, and Sn (FIGS. 13A-13C). It was noteworthy that following zinc deposition, the distribution of zinc in the LM alloy was also highly uniform, thanks to the low migration energy barrier of zinc atoms within the alloy. In addition, no zinc was detected in the elemental maps of LM alloy after discharge, indicating that the EGaInSnZn alloy was fully capable of returning to the EGaInSn. Inductively coupled plasma mass spectrometry (ICP-MS) tests in the LM alloys before and after charge were consistent with this conclusion. (FIG. 14). These results indicated that the deposition/dissolution process of zinc in LM alloys, namely, the alloying/dealloying reaction of zinc in LM, was completely reversible.

### Example 7—Influence of Varied Zinc Deposition Processes on ZIFB Internal Structure

The morphologies and surface fluctuation of electrode and membrane after 3 h electrodepositing at a current density of 40 mA cm⁻² were observed by SEM and super depth surface profile measurement microscope (SDM, VK-8550).

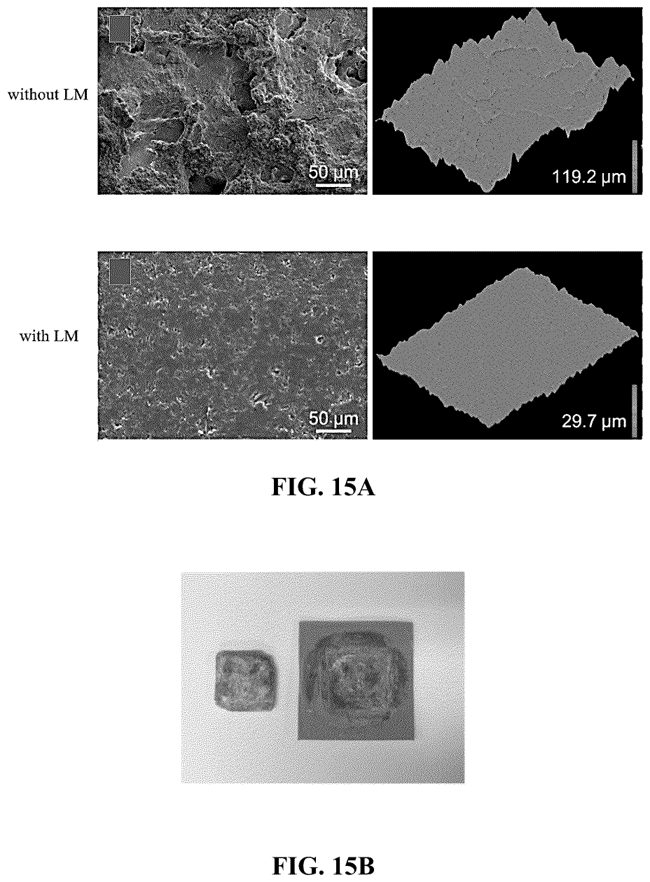

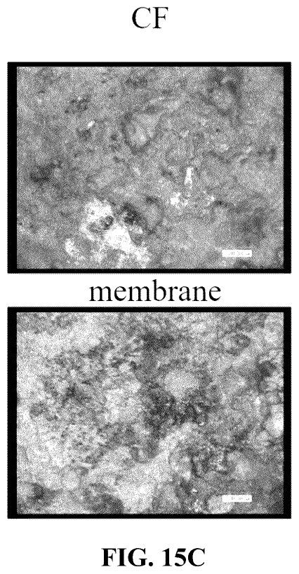

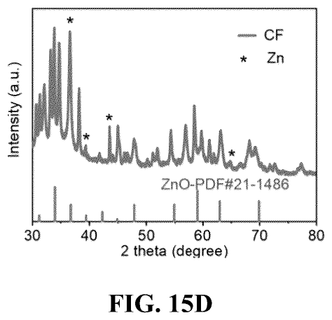

Referring to FIGS. 15A-15C, for the carbon felt (CF) electrode, after the capacity exceeded the load-bearing value, the deposited zinc appeared to have been dispersed in islands, featuring zinc boulders and dendrites. In FIG. 15A, it was also observed that the surface of the deposit fluctuated violently, with the height difference between the highest and lowest points reaching approximately 119.2 μm. In addition, the XRD result confirmed the presence of a large quantity of zinc oxide by-products on the CF (FIG. 15D).

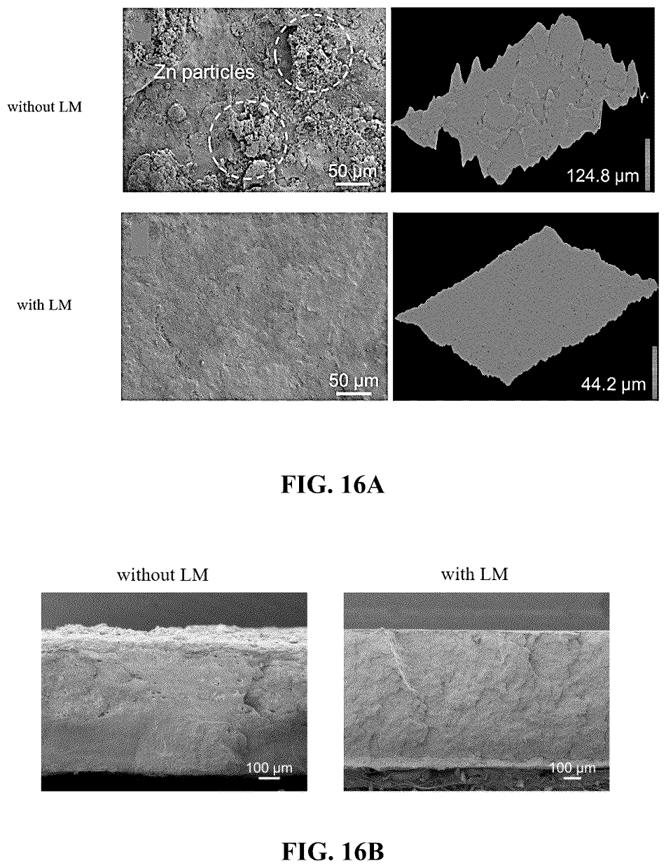

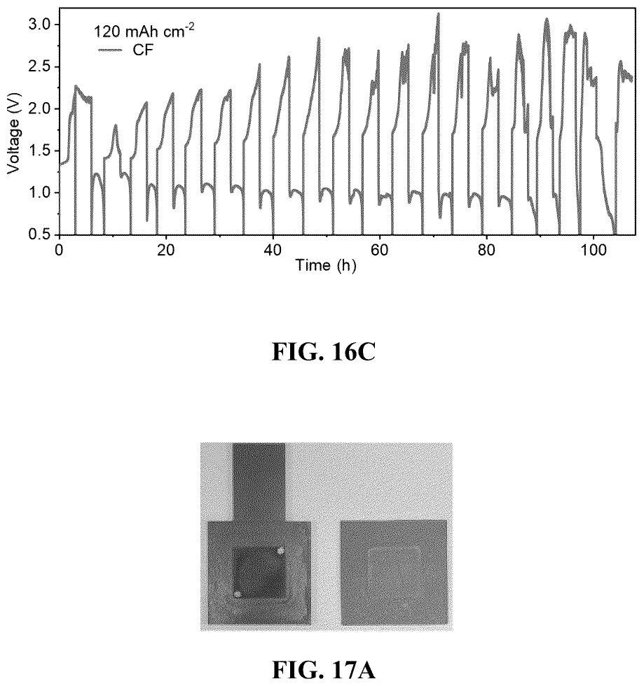

FIGS. 16A-16B showed the surface and cross-section morphologies of membrane after 20^{th} charge. Clearly, zinc dendrites were observed on the surface of the membrane in ZIFBs without LM alloys, with some even penetrating into the membrane. Moreover, the formation of zinc dendrites correlated with the voltage fluctuations observed in the voltage profiles of ZIFBs without LM alloys, as depicted in FIG. 16C.

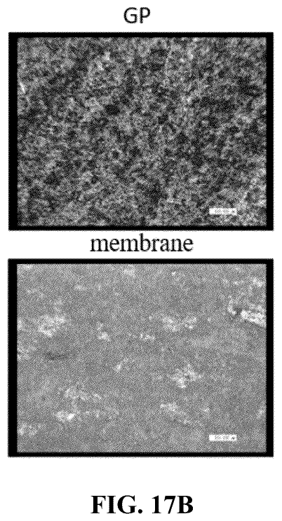

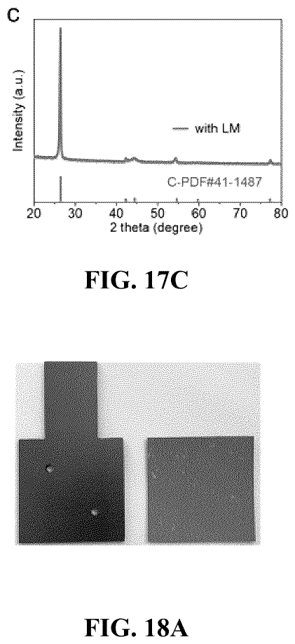

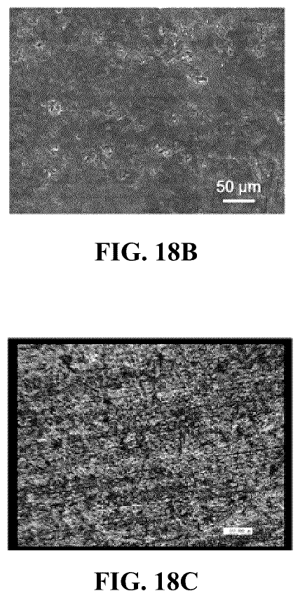

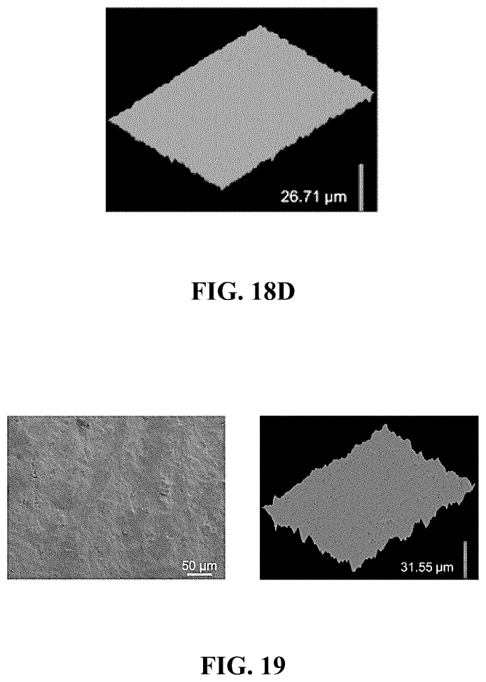

In ZIFBs with LM alloys, the negative side does not utilize CF, reducing the cost of battery accessories. Consequently, the morphology of the graphite plate (GP) electrode in direct contact with the LM was characterized. As shown in bottom of FIG. 15A, the surface morphology and height fluctuations of GP were highly consistent with those before cycling, with only additional traces caused by liquid flow (FIGS. 17A-C and 18A-D).

Furthermore, XRD testing revealed no detection of zinc in the GP collector after charging, suggesting the absence of a liquid-solid deposition process of zinc. After cycling, the morphology of the membrane from ZIFB with LM alloys, including both surface and cross-section, was remarkably well preserved compared to the pristine membrane (FIGS. 16A and 19). These results were consistent with those in FIGS. 5A-5B, which further proved that the LM accepted zinc ions during the charge process to form the liquid EGaInSnZn alloy.

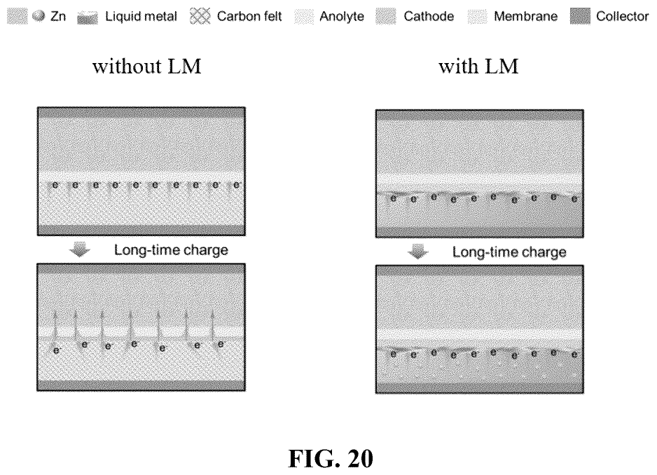

Referring to FIG. 20, the illustrations of zinc deposition processes without and with LM alloys were shown. During the charging process, zinc ions were continuously reduced to metallic zinc on the surface of the CF electrode close to the membrane due to the shortest ion transport path. Once the electrode was completely covered, further plating resulted in a dramatic increase in the polarization of the battery. Consequently, this could have led to an exacerbation of random, uncontrolled growth of zinc dendrites and potential short-circuiting of the battery.

In the present invention, the LM alloys could act as an electrode and current collector based on the alloying/dealloying process of zinc, replacing the liquid-solid conversion zinc electrode. The liquid zinc possessed superior fluidity and deformability and could be circulated between the external electrolyte tank and the reactor, eliminating the space limitations of battery hardware on zinc capacity, and thus allowing for rapid capacity expansion. Moreover, the zincophilic liquid-liquid electrode-electrolyte interface lowered the nucleation barrier and enabled Zn-FBs to operate at high current densities. In addition, the intrinsic self-healing properties of LM alloys that stem from their liquidity and surface tension inhibited the growth of solid dendrite.

### Example 8—Electrochemical Performance of Zn-FBs with LM Alloys

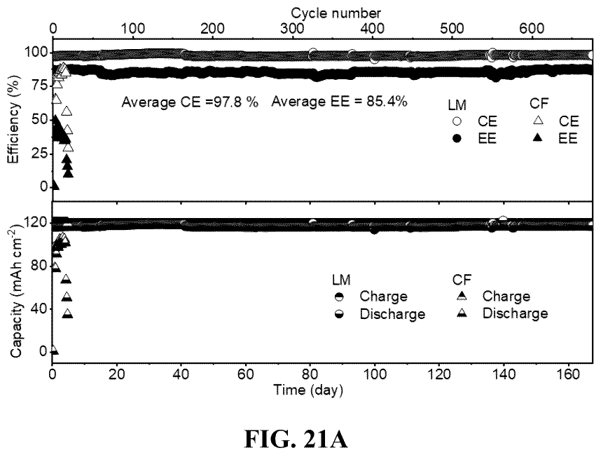

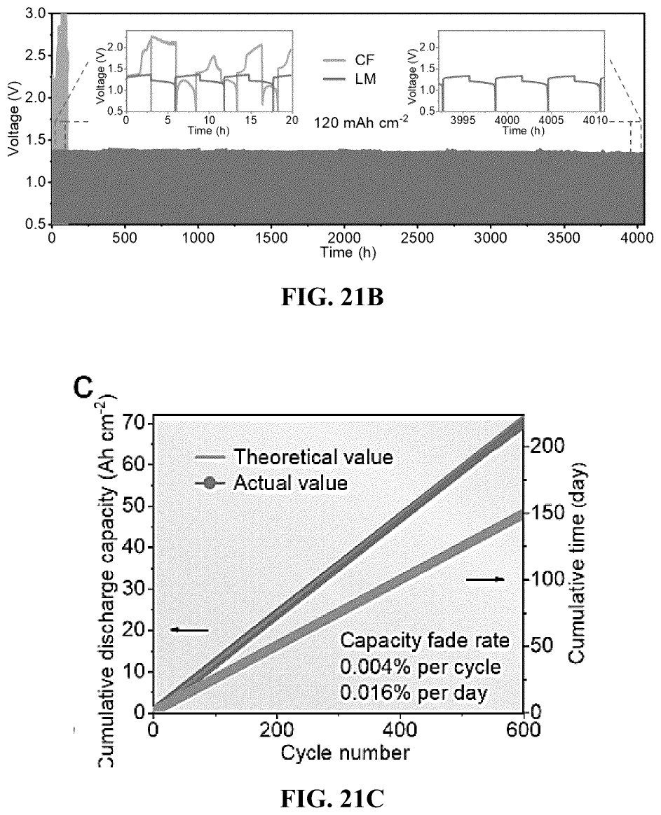

In this example, the long-term cycling stability of liquid-zinc electrode in batteries was further investigated. ZIFBs with and without zinc-deposited LM alloys were tested at high areal capacities and the battery performance was evaluated according to coulombic efficiency (CE) and energy efficiency (EE). Turning to FIG. 21A, even at a high areal capacity of 120 mAh cm⁻², the ZIFB with zinc-deposited LM alloys exhibited steady performance over a period of more than 170 days, which was approximately 40 times long than that without LM alloys, maintained a high average CE of 97.8% and a high average EE of 85.4% at a current density of 40 mA cm⁻². Unfortunately, the CE of ZIFB without zinc-deposited LM alloys gradually decreased to 55.8% within 20 cycles.

To further reveal the details, the voltage-time profiles of the two ZIFBs at 120 mAh cm⁻² were shown in FIG. 21B. Initially, the amount of zinc deposited in the ZIFB without zinc-deposited LM alloys exceeded its upper limit, which caused the rapidly increase of battery polarization. It could be found that the voltage curve of ZIFB without LM fluctuates dramatically after only 5 h of operation, attributing to the short-circuit caused by zinc dendrites. On the contrary, the ZIFB with zinc-deposited LM alloys displayed stable charging/discharging performance for over 4000 h. More significantly, the LM that underwent hundreds of zinc deposition/dissolution cycles remained liquid, visually confirming its stability as an electrode material.

Next, the cumulative discharge capacity was employed to quantify the capacity fade rate of ZIFB with LM alloys. In FIG. 21C, a low-capacity fading rate of 0.004% per cycle and 0.016% per day over 5 months was illustrated, corresponding to a 94.3% capacity retention after 1 year of continuous operation. This demonstrates the excellent reversibility of the zinc-related alloy/dealloy reaction in LM.

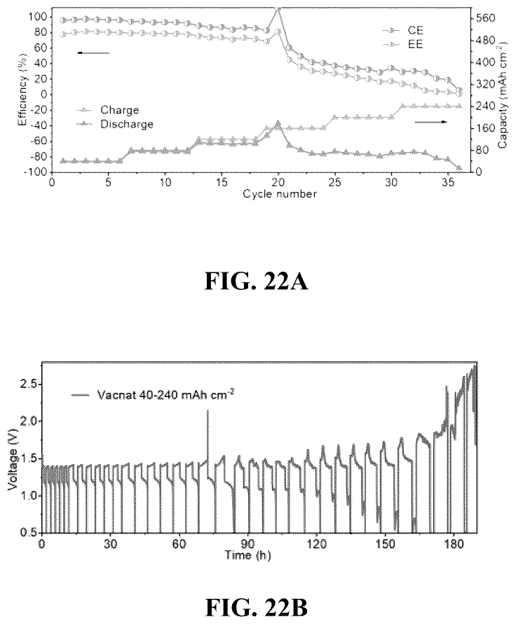

Furthermore, a ZIFB without CF in the negative electrode was assembled, which maximized the deposition space for zinc. Although the tolerable areal capacity of the battery had been improved to 120 mAh cm⁻² compared with ZIFB using CF, as the areal capacity continued to increase, short circuits inevitably occurred in the battery (FIGS. 22A-22B).

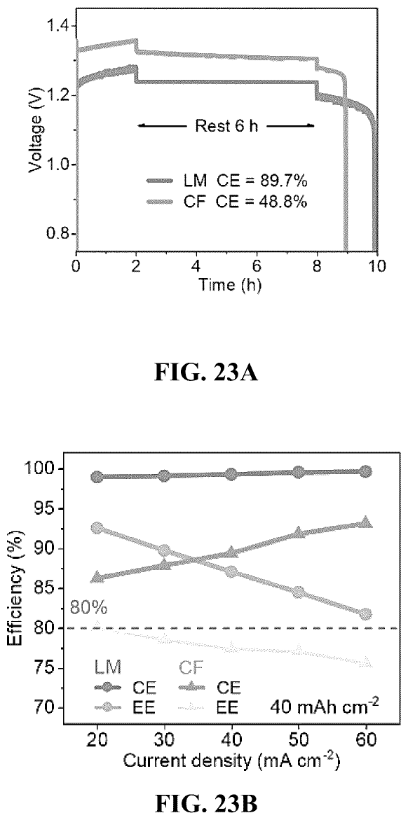

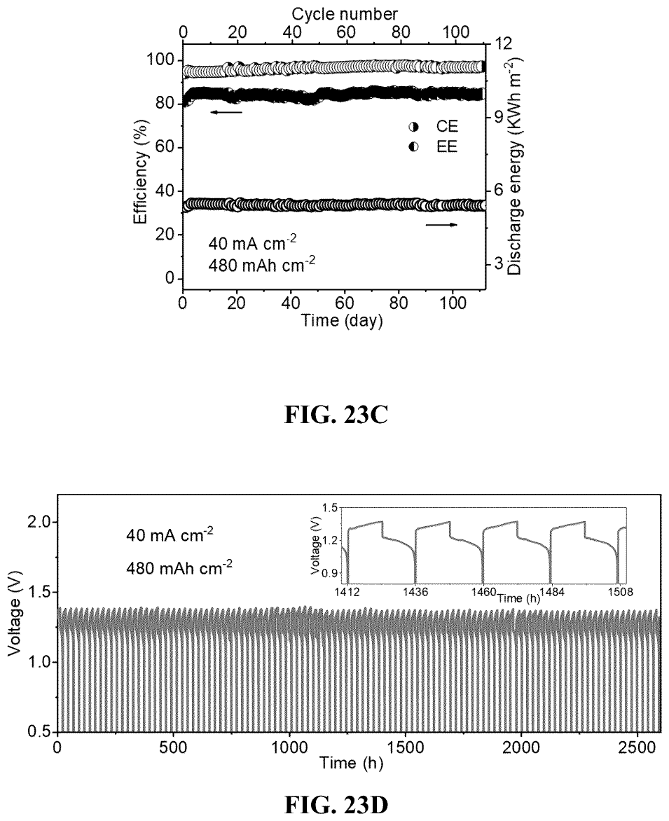

If the inherent liquid-solid phase deposition mode of Zn²⁺/Zn is not altered, the emergence of zinc dendrites is inevitable at such high areal capacity. What's more concerning, this condition will lead to the battery experiencing significantly high polarization, which, in turn, triggers random, uncontrolled growth of zinc dendrites and the formation of irreversible by-products. Referring to FIG. 23A, the fully charged ZIFB with LM released 89.7% of its capacity after 6 h of resting, while the battery without LM only released 48.8% of its capacity. A reduction in voltage hysteresis of about 80 mV was observed after the introduction of zinc-deposited LM alloys compared with the traditional ZIFB. This confirmed that the zinc plating barrier had been significantly reduced, benefiting from the excellent zinc affinity of LM alloys.

Referring to FIG. 23B, the battery offered high performance over wide current density ranges (20-60 mA cm⁻²). FIG. 23C showed that the ZIFB with zinc-deposited LM alloys demonstrated high cycling stability with long discharge/charge durations (about 24 h for each cycle). A high average Coulombic Efficiency (CE) of up to 96.4% and a high average Energy Efficiency (EE) of up to 84.4% were attained. The battery delivered an average discharge energy of approximately 5.44 kWh m 2 per cycle, indicating significant potential for long-duration energy storage. The voltage profiles of the various cycles were depicted in FIG. 23D; minimal alteration in the charge/discharge profile could be observed even after hundreds of cycles, suggesting exceptional and consistent cycling performance.

### Example 9—Preparation of Zinc-Bromine Flow Battery with LM Alloys

In another example, a zinc-bromine flow battery (ZBFB) was prepared as follow: A ZBFB was constructed by sandwiching a porous polyolefin membrane (Daramic) between two carbon felt electrodes, clamped by two graphite plates. An anolyte consisting of 2 mol L⁻¹ ZnBr₂ and 3 mol L⁻¹ KCl was used, but a catholyte including a bromine complexing agent was used to mitigate the diffusion of corrosive bromine, with 0.4 mol L⁻¹ 1-ethyl-1-methylpyrrolidinium bromide added.

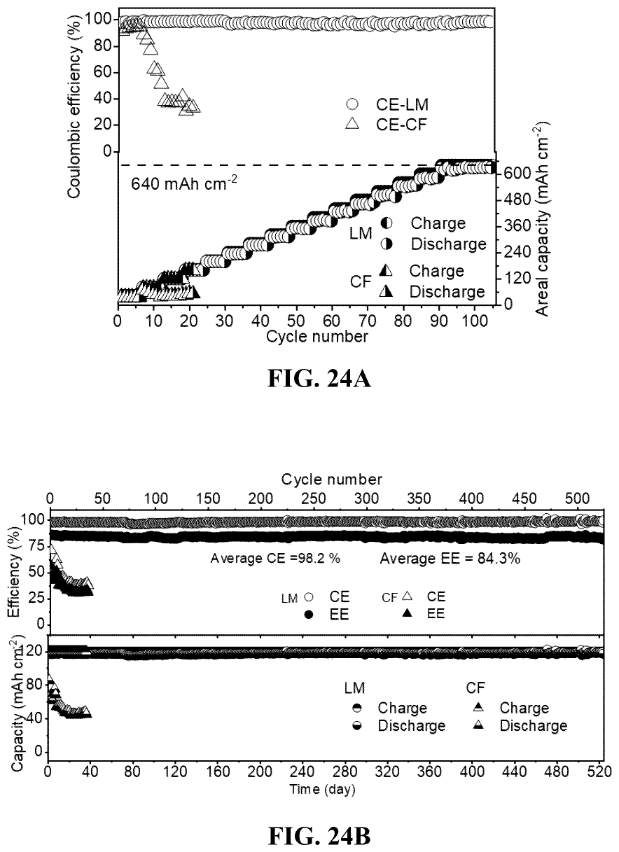

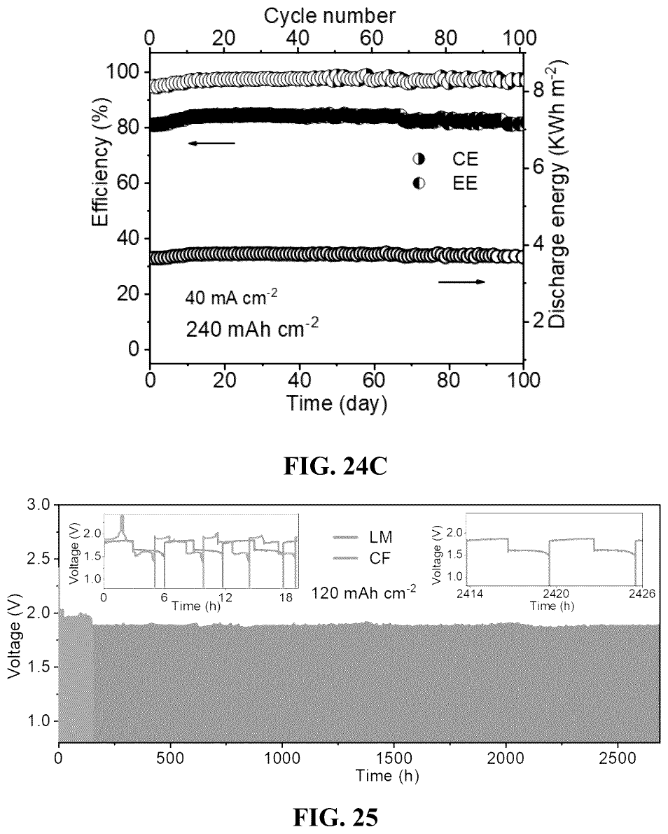

In FIG. 24A, compared with the CF electrode, ultra-high areal capacity up to 640 mAh cm⁻² could be achieved in ZBFB with LM alloys, which was the highest ever reported for the Zn-FBs. The reliability of the liquid-zinc electrode for ZBFB was further demonstrated by its stable cycling performance for over 110 days at an areal capacity of 120 mAh cm⁻² and current density of 40 mA cm⁻², achieving a high average Coulombic Efficiency (CE) of 98.2% and a high average Energy Efficiency (EE) of 84.3% (FIG. 24B).

In further evaluation, the stable voltage profiles over 2600 hours demonstrated its excellent cycle stability, while the voltage profiles of ZBFB without LM fluctuated violently at the first cycle, which was attributed to the short-circuit caused by dendrites piercing into the membrane (FIG. 25).

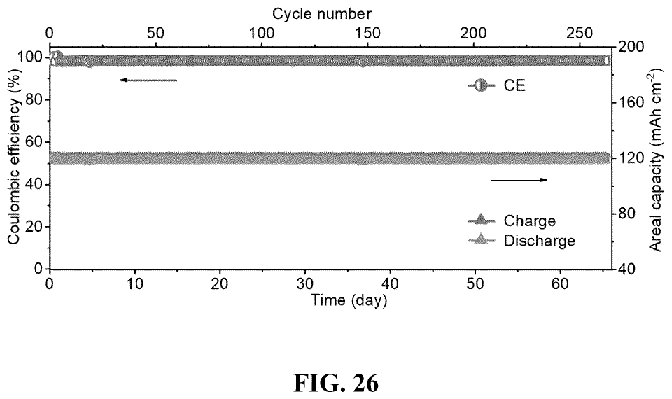

Furthermore, ZBFB with LM alloys was tested at 40 mA cm⁻² for long-duration of 6 h charging and 6 h discharging (FIG. 24C). The battery demonstrated a smooth operation over 50 days with an average CE up to 97.1%, which fully demonstrated the advantages of the designed liquid-zinc electrode. As shown in FIG. 26, other ratios of Ga-LM based on the ZIFB system also demonstrated good cycling stability and high areal capacity, indicating the generalizability of the liquid-zinc chemistry approach to building zinc-based devices for long-duration energy storage.

### Definitions

The term “liquid eutectic alloys”, “liquid metal (LM)” or “Ga-LM” denotes a liquid metal alloy, which is a special type of metal alloy that exhibits liquid properties at room temperature. Unlike most metals, these alloys typically have lower melting points, allowing them to become liquid at relatively low temperatures. This unique characteristic gives liquid metal alloys distinct advantages in many applications, such as manufacturing electronic devices, thermal conductive materials, sealing materials, and more.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### INDUSTRIAL APPLICABILITY

The invention presents a novel approach to tackle the longstanding challenges of zinc dendrite formation and low areal capacity in Zinc-based flow batteries (Zn-FBs), particularly for long-term energy storage applications.

### REFERENCES

The disclosures of the following references are incorporated by reference
1. Zhang J, et al. An all-aqueous redox flow battery with unprecedented energy density. Energy & Environmental Science 11, 2010-2015 (2018).
2 Jin S, et al. Designing interphases for practical aqueous zinc flow batteries with high power density and high areal capacity. Sci Adv 8, eabq4456 (2022).
3. Yang J, et al. Synergetic Modulation on Solvation Structure and Electrode Interface Enables a Highly Reversible Zinc Anode for Zinc-Iron Flow Batteries. ACS Energy Letters 7, 2331-2339 (2022).
4. Lu W, Li T, Yuan C, Zhang H, Li X. Advanced porous composite membrane with ability to regulate zinc deposition enables dendrite-free and high-areal capacity zinc-based flow battery. Energy Storage Materials 47, 415-423 (2022).
5. Yuan Z, et al. Low-cost hydrocarbon membrane enables commercial-scale flow batteries for long-duration energy storage. Joule 6, 884-905 (2022).
6. Jian Q P, Wu M C, Jiang H R, Lin Y K, Zhao T S. A trifunctional electrolyte for high-performance zinc-iodine flow batteries. Journal of Power Sources 484, 229238 (2021).
7. Hu J, et al. Layered double hydroxide membrane with high hydroxide conductivity and ion selectivity for energy storage device. Nature communications 12, 3409 (2021).
8. Chu F, Guo L, Wang S, Cheng Y. Semi-solid zinc slurry with abundant electron-ion transfer interfaces for aqueous zinc-based flow batteries. Journal of Power Sources 535, 231442 (2022).
9. Lei J, Yao Y, Wang Z, Lu Y-C. Towards high-areal-capacity aqueous zinc-manganese batteries: promoting MnO2 dissolution by redox mediators. Energy & Environmental Science 14, 4418-4426 (2021).
10. Luo J, Hu B, Hu M, Wu W, Liu TL. An Energy-Dense, Powerful, Robust Bipolar Zinc-Ferrocene Redox-Flow Battery. Angew Chem Int Ed Engl 61, e202204030 (2022).
11. Park M, et al. A High Voltage Aqueous Zinc-Organic Hybrid Flow Battery. Advanced Energy Materials 9, 1900694 (2019).
12. Yin Y, et al. Dendrite-Free Zinc Deposition Induced by Tin-Modified Multifunctional 3D Host for Stable Zinc-Based Flow Battery. Advanced materials 32, 1906803 (2020).
13. Wu M, et al. Self-Reconstruction of Co/Co2P Heterojunctions Confined in N-Doped Carbon Nanotubes for Zinc-Air Flow Batteries. ACS Energy Letters 6, 1153-1161 (2021).
14. Zhao Z, Soni S, Lee T, Nijhuis C A, Xiang D. Smart Eutectic Gallium-Indium: From Properties to Applications. Advanced materials 35, e2203391 (2023).
15. Kim H, et al. Liquid metal batteries: past, present, and future. Chem Rev 113, 2075-2099 (2013).

1. A dendrite-free zinc-based flow battery with high areal capacity, comprising:
an anode integrated with a first collector;
a cathode integrated with a second collector;
a first storage tank comprising catholyte;
a first pump connects the cathode and the first storage tank;
a second storage tank comprising anolyte and liquid eutectic alloys;
a second pump connects the anode and the second storage tank;
a separator to prevent direct contact between the anolyte and the catholyte,
wherein the catholyte flows through the battery driven by the first pump, and the anolyte and the liquid eutectic alloys flows through the battery driven by the second pump,
wherein the dendrite-free zinc-based flow battery demonstrates an areal capacity of at least 600 mAh cm⁻² at a current density of at least 40 mA cm⁻².

2. The dendrite-free zinc-based flow battery of claim 1, wherein the anode comprises a carbon felt, or a carbon felt with zinc plate or zinc foil added.

3. The dendrite-free zinc-based flow battery of claim 1, wherein the anolyte comprises zinc salts and supporting electrolytes salts with a concentration of 0.5 to 3 mol L-1.

4. The dendrite-free zinc-based flow battery of claim 3, wherein the zinc salts comprise ZnBr₂, ZnCl₂, and ZnI₂, or a combination thereof.

5. The dendrite-free zinc-based flow battery of claim 1, wherein the cathode comprises carbon felt, or a carbon felt absorbed with the catholyte.

6. The dendrite-free zinc-based flow battery of claim 1, wherein the catholyte comprises one or more Cl⁰/Cl⁻, Br₂/Br⁻, I⁰/I⁻, Fe³⁺/Fe²⁺ salts and supporting electrolytes salts with a concentration of 0.5 to 3 mol L⁻¹.

7. The dendrite-free zinc-based flow battery of claim 6, wherein the supporting electrolytes salts comprise NaCl, KCl and NH₄Cl, or a combination thereof.

8. The dendrite-free zinc-based flow battery of claim 1, wherein the liquid eutectic alloys comprise room-temperature liquid metals based on gallium or mercury.

9. The dendrite-free zinc-based flow battery of claim 8, wherein gallium-based room-temperature liquid metals comprise EGaInSnZn alloys, and the EGaInSnZn alloys are capable of returning to EGaInSn alloys after discharge.

10. The dendrite-free zinc-based flow battery of claim 9, the EGaInSnZn alloys exhibit the characteristic broad peak at around 35°.

11. The dendrite-free zinc-based flow battery of claim 9, wherein the EGaInSnZn alloys comprises 50-80 wt % gallium, 10-30 wt % indium, 5-20 wt % tin and 1-10 wt % zinc.

12. The dendrite-free zinc-based flow battery of claim 1, wherein the separator comprises porous membrane or an ion exchange membrane with a thickness of 10 to 200 μm.

13. The dendrite-free zinc-based flow battery of claim 1, wherein the first collector or the second collector comprises graphite plate, carbon plastic composite plate or titanium plate.

14. The dendrite-free zinc-based flow battery of claim 1, wherein the dendrite-free zinc-based flow battery exhibits at least 95% of coulombic efficiency, at least 84% of energy efficiency even if the areal capacity is increased up to 640 mAh cm⁻².

15. The dendrite-free zinc-based flow battery of claim 1, wherein the volume ratio between anolyte:LM is in a range of 5 to 20.

16. The dendrite-free zinc-based flow battery of claim 1, wherein the dendrite-free zinc-based flow battery maintains a cycle life of at least 110 days even at an areal capacity of 120 mAh cm⁻².

17. The dendrite-free zinc-based flow battery of claim 1, wherein the dendrite-free zinc-based flow battery displays a stable charging/discharging performance for over 4000 hours.
